(19) United States
(12) Patent Application Publication
(10) Pub. No.: US 2009/0019055 A1
(43) Pub. Date: Jan. 15, 2009

(54) Method and system for replacing content displayed by an electronic device

(75) Inventor: Christopher A. White, Redmond, WA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: Disney Enterprises, Inc.

(21) Appl. No.: 11/827,923

(22) Filed: Jul. 13, 2007

(51) Int. Cl. G06F 17/30

(52) U.S. Cl. 707/10; 707/E17.032

(57) ABSTRACT

According to one embodiment, a method for use by an electronic device for automatically replacing a first content being displayed by the electronic device with a second content includes receiving user preference data input by a user. The method further includes detecting an occurrence of a trigger event and selecting the second content from a predetermined location in response to the trigger event. The method further includes receiving the second content from the predetermined location and configuring the electronic device to display the second content.

### BACKGROUND OF THE INVENTION

1. Field of the Invention

The present invention relates generally to techniques for controlling content being displayed by electronic devices. More particularly, the present invention relates to techniques for automating the replacement of content displayed by electronic devices.

2. Background Art

A conventional electronic device, such as a cellular telephone or a desktop computer, can typically be configured to display content on its output display. For example, a cellular telephone may be configured to display a predetermined image, such as an image of a sunset, during periods when the cellular telephone is on. A user of the electronic device can typically purchase such content (also referred to as a background image or “wallpaper”) from a content provider and can configure the electronic device to display the content.

However, it can be very inconvenient and time consuming for a user to replace the content being displayed by the electronic device with new content. For example, to replace the content being displayed by the electronic device, the user is typically required to first browse the content provider's library of content and to select the new content to be displayed. Then, the user must purchase the new content, which can typically be delivered directly to the electronic device. Once the new content is received, the user is usually required to navigate through numerous option menus of the electronic device in order to select the new content and to set the new content as the background image. These inconveniences involved in the replacement of content displayed by conventional electronic devices effectively limits the user's exposure to new content and the amount of new content the user might ultimately purchase. As a result, conventional electronic devices are preventing content providers from realizing considerable revenues that can be generated from the distribution of new content.

### SUMMARY OF THE INVENTION

There is provided methods and systems for replacing content displayed by an electronic device, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 illustrates a block diagram of an electronic device configured to automatically replace content being displayed by the electronic device, in accordance with one embodiment of the invention; and

FIG. 2 shows a flowchart for performing a method for replacing content displayed by an electronic device, in accordance with one embodiment of the invention.

### DETAILED DESCRIPTION OF THE INVENTION

Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

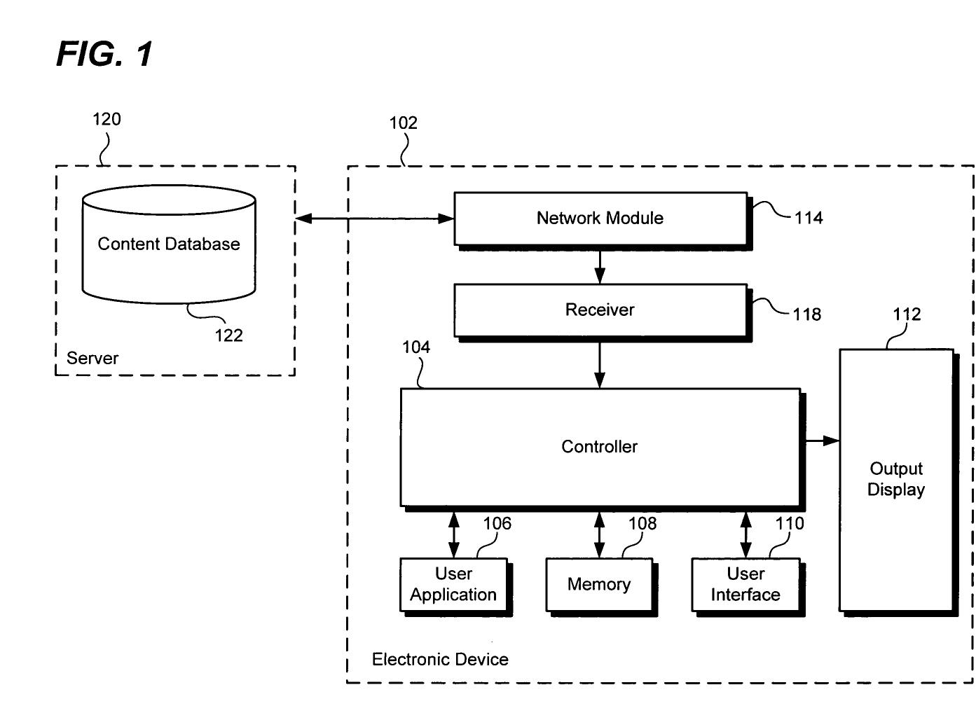

FIG. 1 illustrates a block diagram of electronic device 102 configured to automatically replace content being displayed by the electronic device, in accordance with one embodiment of the invention. Electronic device 102 includes controller 104, user application 106, memory 108, user interface 110, output display 112, network module 114, and receiver 118. In one embodiment, electronic device 102 can be a mobile device, such as a cellular telephone, a personal digital assistant, or a laptop computer. In another embodiment, electronic device 102 can be a desktop computer or any other electronic device having a display.

As shown in FIG. 1, controller 104 is coupled to receiver 118, memory 108, user interface 110, and output display 112. Controller 104 can be, for example, a microprocessor or a central processing unit (“CPU”). As also shown in FIG. 1, controller 104 is in communication with user application 106. In one embodiment, user application 106 can be stored in a non-volatile memory device, such as a flash memory device. As further shown in FIG. 1, network module 114 is coupled to receiver 118. Network module 114 can be, for example, a Wi-Fi module, a Bluetooth module, an Ethernet adapter, or any other type of network communication device. In one embodiment, network module 114 can include a radio frequency (“RF”) module configured to communicate with one or more cellular networks that support a bandwidth suited for data, image and video communications, such as General Packet Radio Service (“GPRS”) or 1 xEV-DO.

Electronic device 102 in FIG. 1 can be configured to display content on output display 112. Output display 112 can be, for example, any type of display for viewing content, such as a liquid crystal display (“LCD”) or a plasma display. The content can be, for example, an image or a video, which can be displayed on output display 112 as a background (also referred to as “wallpaper”) during periods when electronic device 102 is on.

As discussed below, user application 106 can be configured to automatically replace content being displayed by electronic device 102 with new content. The new content can be, for example, an image or a video. In one embodiment, user application 106 can be configured to detect the occurrence of a trigger event, and to select new content from a predetermined location in response to the trigger event. The trigger event can be, for example, a predetermined time, an incoming Short Message Service (“SMS”) message, or an incoming Multimedia Message Service (“MMS”) message.

In one embodiment, the predetermined location from where the new content is to be selected can be configured by a user. In such an embodiment, user application 106 can be configured to receive user preference data, which can specify various preferences of the user. The user preference data can include, for example, the location from where the new content is to be selected. The user preference data can further include various attributes of the new content, such as the category of the new content (e.g., Disney animated images, Disney movie screenshots, holiday images, calendar images, etc.) and the type of the new content (e.g., still image or video). In one embodiment, the user may input the user preference data through user interface 110. User interface 110 can include, for example, various input devices such as a keyboard, a keypad, and/or a pointing device (e.g., a mouse). In another embodiment, the user can input the user preference data into a website hosted by a content provider, which can then transmit the user preference data to electronic device 102 using techniques known in the art. The user preference data can be received in receiver 118 via network module 114 and provided to user application 106.

In one embodiment, the location from where the new content is to be selected can be an external device, such as server 120 shown in FIG. 1. As shown in FIG. 1, electronic device 102 is in communication with server 120 via network module 114. Server 120 can be, for example, a Web server or a file server. As further shown in FIG. 1, server 120 includes content database 122, which can include a library of various new content that can be received and displayed by electronic device 102. Thus, user application 106 can be configured to detect a trigger event and to select new content from content database 122 in response to the trigger event. In one embodiment, user application 106 can be configured to select the new content based on the user preference data input by the user. For example, user application can be configured to select new content that matches the attributes specified by the user preference data.

In another embodiment, the location from where the new content is to be selected can be a local device, such as memory 108. Memory 108 can be, for example, a nonvolatile memory device, such as a flash memory device or a hard disk. Accordingly, memory device 108 can be loaded with new content prior to a trigger event. In one embodiment, each new content in memory device 108 can be associated with metadata that includes information that can be used by user application 106 to properly select the new content. For example, the metadata can describe the attributes of the new content, such as the category of the new content (e.g., Disney animated images, Disney movie screenshots, holiday images, calendar images, etc.) and the type of the new content (e.g., still image or video). The metadata can further include, for example, one or more trigger events that the new content might be associated with. For example, if the new content is an image of Mickey Mouse eating lunch, then the associated trigger event included in the metadata might be a predetermined time at which the image should be displayed, such as 12:00 p.m. Accordingly, at 12:00 p.m., user application 106 can analyze the metadata of the image of Mickey Mouse and can select the image of Mickey Mouse for display on output display 112. Thus, as discussed above, user application 106 can be configured to detect a trigger event and to select new content from memory device 108 in response to the trigger event. In one embodiment, user application 106 can be configured to select the new content based on the user preference data input by the user. For example, user application 106 can be configured to select new content that matches the attributes specified by the user preference data.

Once the new content has been selected using any one of the techniques described above, user application 106 can receive the new content. For example, if the new content selected by user application 106 resides in server 120, the new content can be received at receiver 118 via network module 114. In one embodiment, the content can be delivered to and received by electronic device 102 using a messaging protocol, such as a Multimedia Message Service (“MMS”) protocol. Receiver 118 can be, for example, a volatile or non-volatile memory device configured to buffer the new content. The new content can then be retrieved from receiver 118 by controller 104 and provided to user application 106. As another example, if the new content selected by user application 106 resides in memory device 108, the new content can be retrieved from memory device 108 by controller 104 and provided to user application 106.

After receiving the new content, user application 106 can automatically configure electronic device 102 to display the new content. In other words, user application 106 can be configured to remove the content being displayed on output display 112 and to display the new content. In one embodiment, user application 106 can delete the content that was previously displayed by electronic device 102. In another embodiment, the content that was previously displayed by electronic device 102 can be stored in a memory, such as memory 108.

An example operation of user application 106 will now be discussed with reference to FIG. 1. According to one embodiment of the invention, content database 122 in server 120 can include one or more sets of calendar images having various themes, such as “Mickey Mouse and Friends” or “Pooh and Friends.” The user may select a particular set of calendar images by inputting the appropriate user preference data through user interface 110 in a manner described above. Thereafter, at a predetermined time each day, user application 106 can be configured to select and receive an image from the calendar corresponding to the present date. For example, on the first of the month, user application 106 can select and receive an image of Mickey Mouse standing next to the number “1.” Thereafter, user application 106 can configure controller 104 to display the image on output display 112. On the following day, i.e., the second of the month, user application 106 can select and receive an image of Minnie Mouse standing next to the number “2.” User application 106 can then replace the image of Mickey Mouse standing next to the number “1” with the image of Minnie Mouse standing next to the number “2.” Thus, user application 106 can be configured to automatically replace the content being displayed (i.e., a calendar image corresponding to a prior date) with new content (i.e., a calendar image corresponding to the present date). Thus, it can be appreciated by one of ordinary skill in the art that the user does not have to reconfigure electronic device 102 in order to replace the content being displayed, since user application 106 can be configured to automatically replace the content being displayed by electronic device 102. Moreover, it can also be appreciated that user application 106 allows a user to advantageously control the new content to be displayed in response to a particular trigger event by, for example, allowing the user to assign the new content to a trigger event through the user preference data described above.

In another example operation of user application 106, memory 108 can be loaded with a predetermined set of images that can be displayed by electronic device 102. For example, the set of images can include an image of Mickey Mouse waking up, an image of Minnie Mouse talking on the phone, and an image of Donald Duck sleeping. Each of the images can be associated with metadata as described above. User application 106 can be configured to detect a trigger event and to select an image from the set of images in memory 108 that is associated with the trigger event. For example, the image of Mickey Mouse waking up can be associated with metadata that specifies a trigger event defined as the time 7:00 a.m., while the image of Donald Duck can be associated with metadata that specifies a trigger event defined as the time 10:00 p.m. Thus, at 7:00 a.m., user application 106 can select an image from the set of images associated with a trigger event of 7:00 a.m., such as the image of Mickey Mouse waking up. User application 106 can then receive the image of Mickey Mouse and can configure controller 104 to display the image on output display 112. Then at 10:00 p.m., user application 106 can select an image from the set of images associated with a trigger event of 10:00 p.m., such as the image of Donald Duck sleeping. User application 106 can then receive the image of Donald Duck and can configure controller 104 to display the image on output display 112. Thus, according to this example, user application 106 can be configured to automatically replace an image being displayed by electronic device 102 with a new image at a predetermined time by selecting an image associated with the predetermined time. As a result, the invention advantageously allows the content displayed by electronic device 102 to change automatically at various times each day without requiring any further configuration by the user.

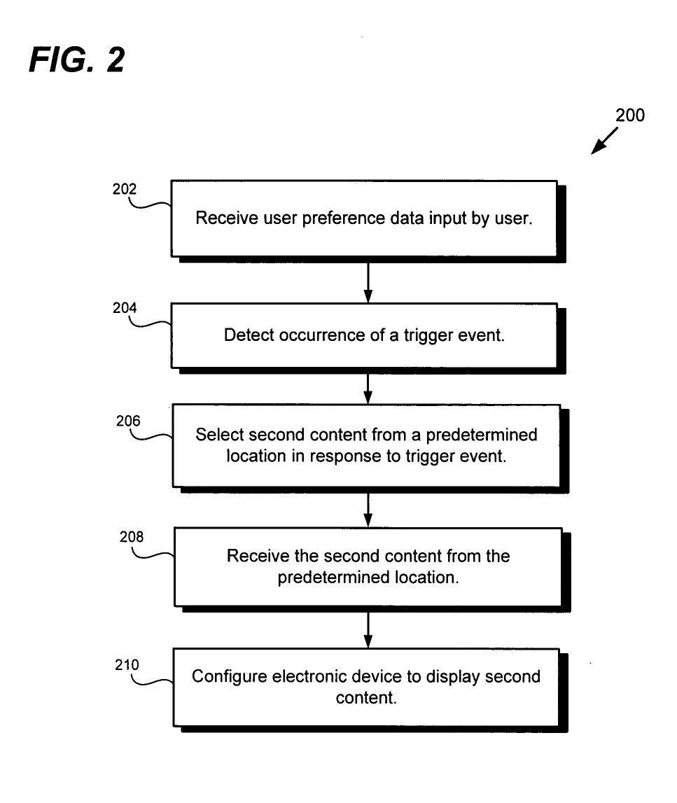

FIG. 2 shows a flowchart for performing method 200 for replacing content displayed by an electronic device in accordance with one embodiment of the invention. As shown in FIG. 2 and with reference to FIG. 1, at step 202 of flowchart 200, user preference data input by a user is received. At step 204, an occurrence of a trigger event is detected. At step 206, a second content, i.e., new content, is selected from a predetermined location in response to the trigger event. Thereafter, at step 208, the second content is received from the predetermined location in receiver 118. At step 210, the electronic device is configured to display the second content.

Thus, the invention enables an electronic device to automatically replace the content being displayed by the electronic device. As a result, the invention can expose users of electronic devices to more of the content being distributed by content providers, which can advantageously increase the amount of content sold by the content providers. Furthermore, since the invention allows the content to be received and displayed by the electronic devices automatically, content providers can enter into lucrative subscription agreements with the users of the electronic devices to automatically provide various content to the electronic devices over a predetermined period of time. As such, the appearance of the electronic devices can be substantially enhanced by the invention by periodically and conveniently replacing the content being displayed by the electronic devices.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. For example, it is contemplated that the circuitry disclosed herein can be implemented in software, or vice versa. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for use by a mobile electronic device for automatically replacing a first content being displayed by said mobile electronic device with a second content, said method comprising:
receiving user preference data input by a user;
detecting an occurrence of a trigger event;
selecting said second content from a predetermined location in response to said trigger event;
receiving said second content from said predetermined location;
configuring said mobile electronic device to display said second content.

2. The method of claim 1 wherein said trigger event is one of an incoming Short Message Service (“SMS”) message, an incoming Multimedia Message Service (“MMS”) message, or a predetermined time.

3. The method of claim 1 wherein said second content is associated with metadata.

4. The method of claim 3 wherein said metadata includes a category of said second content, a type of said second content, and trigger event data.

5. The method of claim 1 wherein said second content matches said user preference data.

6. The method of claim 1 wherein said second content is associated with said trigger event.

7. The method of claim 1 wherein said predetermined location is one of an external device or a local device.

8. The method of claim 1 wherein said receiving said second content is performed using a Multimedia Message Service (“MMS”) protocol.

9. The method of claim 1 wherein said mobile electronic device is one of a cellular telephone, a personal digital assistant (“PDA”), or a laptop computer.

10. The method of claim 1 wherein said second content is one of an image or a video.

11. A mobile electronic device configured to automatically replace a first content being displayed by said mobile electronic device with a second content, said mobile electronic device comprising:
a controller configured to receive user preference data input by a user and to detect an occurrence of a trigger event, said controller being configured to select a second content from a predetermined location in response to said trigger event;
a receiver for receiving said second content from said predetermined location;
an output display coupled to said controller, wherein said controller is configured to display said second content on said output display.

12. The mobile electronic device of claim 11 wherein said trigger event is one of an incoming Short Message Service (“SMS”) message, an incoming Multimedia Message Service (“MMS”) message, or a predetermined time.

13. The mobile electronic device of claim 11 wherein said second content is associated with metadata.

14. The mobile electronic device of claim 13 wherein said metadata includes a category of said second content, a type of said second content, and trigger event data.

15. The mobile electronic device of claim 11 wherein said second content matches said user preference data.

16. The mobile electronic device of claim 11 wherein said second content is associated with said trigger event.

17. The mobile electronic device of claim 11 wherein said predetermined location is one of an external device or a local device.

18. The mobile electronic device of claim 11 wherein said receiving said second content is performed using a Multimedia Message Service (“MMS”) protocol.

19. The mobile electronic device of claim 11 wherein said mobile electronic device is one of a cellular telephone, a personal digital assistant (“PDA”), or a laptop computer.

20. The mobile electronic device of claim 11 wherein said second content is one of an image or a video.
